(19) United States
(12) Patent Application Publication
(10) Pub. No.: US 2025/0249916 A1
(43) Pub. Date: Aug. 7, 2025

(54) VEHICLE CONTROL APPARATUS AND METHOD THEREOF

(71) Applicants: HYUNDAI MOTOR COMPANY, Seoul (KR); Kia Corporation, Seoul (KR); HYUNDAI AUTOEVER Corp., Seoul (KR)

(72) Inventors: Wang Seok LEE, Hwaseong-si (KR); Bong Ju KIM, Yongin-si (KR)

(73) Assignees: HYUNDAI MOTOR COMPANY, Seoul (KR); Kia Corporation, Seoul (KR); HYUNDAI AUTOEVER Corp., Seoul (KR)

(21) Appl. No.: 18/815,165

(22) Filed: Aug. 26, 2024

(30) Foreign Application Priority Data
Feb. 7, 2024 (KR) 10-2024-0019143

(51) Int. Cl. B60W 50/035; B60W 50/02

(52) U.S. Cl. CPC B60W 50/035; B60W 50/0205

(57) ABSTRACT

A vehicle control apparatus performs a first peripheral component interconnect express (PCIe) reset and a first link-up for PCIe communication between target devices, determines a PCIe parameter, based on at least one of a communication speed between the target devices, abnormal information, whether a fault is identified, or real-time temperatures of the target devices, or any combination thereof, performs a second PCIe reset for the target devices, in response that the controller concludes that a PCIe reset trigger is generated, and performs a second link-up between the target devices based on the determined PCIe parameter, if the second PCIe reset is completed.

### CROSS-REFERENCE TO RELATED APPLICATION

The present application claims priority to Korean Patent Application No. 10-2024-0019143, filed on Feb. 7, 2024, the entire contents of which is incorporated herein for all purposes by this reference.

### BACKGROUND OF THE PRESENT DISCLOSURE

### Field of the Present Disclosure

The present disclosure relates to a vehicle control apparatus and a method thereof, and more particularly, relates to technologies for smoothly performing communication (e.g., peripheral component interconnect express) (PCIe) communication) between controller units for controlling a host vehicle.

### Description of Related Art

With the development of vehicle control technology, a plurality of control units for controlling various functions of a host vehicle may be loaded into the host vehicle. The plurality of control units may be operatively connected to each other based on various types of communication algorithms to transmit and receive pieces of data.

For example, the plurality of control units for controlling the host vehicle may transmit and receive pieces of data based on PCIe communication which is a high-speed communication interface.

The PCIe communication has a relatively high communication speed. However, the PCIe communication includes a physical layer (PHY) configuration which is very sensitive to various environmental factors (e.g., a temperature, impedance, and the like). Thus, there may occur a situation in which communication performance between the plurality of control units is unstable in the process of performing the PCIe communication.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle control apparatus for adaptively changing a PCIe parameter (e.g., a PCIe configuration) to maintain stable communication performance, if deterioration in communication performance is identified, after performing a reset for target devices for performing PCIe communication and/or while the target devices perform the PCIe communication, and a vehicle control method.

Another aspect of the present disclosure provides a vehicle control apparatus for performing a link-up between target devices again based on a PCIe parameter determined according to a magnitude of a communication speed if a PCIe reset trigger for instructing to reset the target devices again is generated, if a communication speed is less than a maximum speed according to the link-up, after performing the link-up for PCIe communication, and a vehicle control method.

Another aspect of the present disclosure provides a vehicle control apparatus for performing a reset and a link-up for target devices again based on a PCIe parameter determined according to a fault if the fault is included in the recoverable range, in response that the controller identifies that the fault occurs in a process of performing PCIe communication in the target devices, and storing information related to the fault in a memory, if the fault occurring is included in the recoverable range, and a vehicle control method.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a communication device, a memory storing at least one instruction, and a controller operatively connected to the communication device and the memory. For example, the at least one instruction may be configured to, when executed by the controller, cause the vehicle control apparatus to perform a first peripheral component interconnect express (PCIe) reset and a first link-up for PCIe communication between target devices, using the communication device, determine a PCIe parameter, based on at least one of a communication speed between the target devices, abnormal information, whether a fault is identified, or real-time temperatures of the target devices, or any combination thereof, perform a second PCIe reset for the target devices, in response that the controller concludes that a PCIe reset trigger is generated, and perform a second link-up between the target devices based on the determined PCIe parameter, in response that the second PCIe reset is completed.

According to an exemplary embodiment of the present disclosure, the at least one instruction may be configured to, when executed by the controller, cause the vehicle control apparatus to monitor whether the target devices enter a reset safety state, in response that the controller identifies that the communication speed between the target devices is less than a predetermined speed, and determine the PCIe parameter based on the communication speed, in response that the controller identifies that the target devices enter the reset safety state.

According to an exemplary embodiment of the present disclosure, the at least one instruction may be configured to, when executed by the controller, cause the vehicle control apparatus to control a host vehicle using one of the target devices by the controller, control the host vehicle using the target devices without using the PCIe communication by the controller, or determine that the target devices enter the reset safety state, in response that the controller identifies that a time required to perform a reset for the target devices in a situation in which the controller controls the host vehicle using the target devices based on the PCIe communication is less than or equal to a predetermined time.

According to an exemplary embodiment of the present disclosure, the at least one instruction may be configured to, when executed by the controller, cause the vehicle control apparatus to determine that the PCIe reset trigger is generated, in response that the controller identifies that a power state of the vehicle control apparatus switches from OFF to ON.

According to an exemplary embodiment of the present disclosure, the at least one instruction may be configured to, when executed by the controller, cause the vehicle control apparatus to monitor whether abnormal information related to communication performance while performing the PCIe communication between the target devices is identified, in response that the first link-up is completed, and determine the PCIe parameter based on the abnormal information, in response that the abnormal information is identified.

According to an exemplary embodiment of the present disclosure, the at least one instruction may be configured to, when executed by the controller, cause the vehicle control apparatus to determine that the abnormal information is identified, in response that the controller concludes that the communication speed is less than a first speed according to the first link-up or that the PCIe communication does not meet a link training & status state machine (LTSSM) according to the first link-up.

According to an exemplary embodiment of the present disclosure, the at least one instruction may be configured to, when executed by the controller, cause the vehicle control apparatus to monitor whether the fault is identified while performing the PCIe communication, in response that the controller concludes that the communication speed is greater than or equal to a predetermined speed and that the abnormal information is not identified, determine whether the fault is included in a recoverable range, if the fault is identified, monitor whether the target devices enter a reset safety state, if the fault is included in the recoverable range, and determine the PCIe parameter based on information related to the fault, in response that the controller identifies that the target devices enter the reset safety state.

According to an exemplary embodiment of the present disclosure, the at least one instruction may be configured to, when executed by the controller, cause the vehicle control apparatus to monitor whether the fault is identified while performing the PCIe communication, in response that the controller concludes that the communication speed is greater than or equal to a predetermined speed and that the abnormal information is not identified, determine whether the fault is included in a recoverable range, if the fault is identified, and identify the fault as a permanent fault and store information related to the fault in the memory, in response that the fault is not included in the recoverable range.

According to an exemplary embodiment of the present disclosure, the vehicle control apparatus may further include a sensor device. For example, the at least one instruction may be configured to, when executed by the controller, cause the vehicle control apparatus to identify at least one of an external temperature or impedance of the target devices, or any combination thereof, using the sensor device and determine that the fault is included in the recoverable range, in response that the controller identifies that the fault occurs due to the external temperature or the impedance or in response that the controller identifies that the fault includes a communication delay due to dependency between the target devices.

According to an exemplary embodiment of the present disclosure, the vehicle control apparatus may further include a sensor device. For example, the at least one instruction may be configured to, when executed by the controller, cause the vehicle control apparatus to obtain the real-time temperature of each of the target devices, using the sensor device and determine the PCIe parameter, based on a result of comparing the real-time temperatures of the target devices.

According to another aspect of the present disclosure, a vehicle control method may include performing, by a controller, a first peripheral component interconnect express (PCIe) reset and a first link-up for PCIe communication between target devices, using a communication device, determining, by the controller, a PCIe parameter, based on at least one of a communication speed between the target devices, abnormal information, whether a fault is identified, or real-time temperatures of the target devices, or any combination thereof, performing, by the controller, a second PCIe reset for the target devices, in response that the controller concludes that a PCIe reset trigger is generated, and performing, by the controller, a second link-up between the target devices based on the determined PCIe parameter, in response that the second PCIe reset is completed.

According to an exemplary embodiment of the present disclosure, the vehicle control method may further include monitoring, by the controller, whether the target devices enter a reset safety state, in response that the controller identifies that the communication speed between the target devices is less than a predetermined speed, and determining, by the controller, the PCIe parameter based on the communication speed, in response that the controller identifies that the target devices enter the reset safety state.

According to an exemplary embodiment of the present disclosure, the vehicle control method may further include controlling, by the controller, a host vehicle using one of the target device, controlling, by the controller, the host vehicle using the target devices without using the PCIe communication, or determining, by the controller, that the target devices enter the reset safety state, in response that the controller identifies that a time required to perform a reset for the target devices in a situation in which the controller controls the host vehicle using the target devices based on the PCIe communication is less than or equal to a predetermined time.

According to an exemplary embodiment of the present disclosure, the vehicle control method may further include determining, by the controller, that the PCIe reset trigger is generated, in response that the controller identifies that a power state of the vehicle control apparatus switches from OFF to ON.

According to an exemplary embodiment of the present disclosure, the vehicle control method may further include monitoring whether the abnormal information related to communication performance while performing the PCIe communication between the target devices is identified, in response that the first link-up is completed, and determining, by the controller, the PCIe parameter based on the abnormal information, in response that the abnormal information is identified.

According to an exemplary embodiment of the present disclosure, the vehicle control method may further include determining, by the controller, that the abnormal information is identified, in response that the controller concludes that the communication speed is less than a first speed according to the first link-up or that the PCIe communication does not meet a link training & status state machine (LTSSM) according to the first link-up.

According to an exemplary embodiment of the present disclosure, the vehicle control method may further include monitoring, by the controller, whether the fault is identified while performing the PCIe communication, in response that the controller concludes that the communication speed is greater than or equal to a predetermined speed and that the abnormal information is not identified, determining, by the controller, whether the fault is included in a recoverable range, if the fault is identified, monitoring whether the target devices enter a reset safety state, if the fault is included in the recoverable range, and determining, by the controller, the PCIe parameter based on information related to the fault, in response that the controller identifies that the target devices enter the reset safety state.

According to an exemplary embodiment of the present disclosure, the vehicle control method may further include monitoring, by the controller, whether the fault is identified while performing the PCIe communication, in response that the controller concludes that the communication speed is greater than or equal to a predetermined speed and that the abnormal information is not identified, determining, by the controller, whether the fault is included in a recoverable range, if the fault is identified, and identifying, by the controller, the fault as a permanent fault and storing, by the controller, information related to the fault in a memory, in response that the fault is not included in the recoverable range.

According to an exemplary embodiment of the present disclosure, the vehicle control method may further include identifying at least one of an external temperature or impedance of the target devices, or any combination thereof, using a sensor device operatively connected to the controller, and determining, by the controller, that the fault is included in the recoverable range, in response that the controller identifies that the fault occurs due to the external temperature or the impedance or in response that the controller identifies that the fault includes a communication delay due to dependency between the target devices.

According to an exemplary embodiment of the present disclosure, the vehicle control method may further include obtaining, by the controller, the real-time temperature of each of the target devices, using a sensor device operatively connected to the controller, and determining the PCIe parameter, based on a result of comparing the real-time temperatures of the target devices.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating components of a vehicle control apparatus according to an exemplary embodiment of the present disclosure;

FIG. 2 is a flowchart of a vehicle control method according to an exemplary embodiment of the present disclosure;

FIG. 3 is a flowchart of a vehicle control method according to an exemplary embodiment of the present disclosure;

FIG. 4 is an operational conceptual diagram of a vehicle control method according to an exemplary embodiment of the present disclosure;

FIG. 5 is a flowchart of a vehicle control method according to an exemplary embodiment of the present disclosure; and

FIG. 6 illustrates a computing system associated with a vehicle control apparatus or a vehicle control method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical component is designated by the identical numerals even when they are displayed on other drawings. Furthermore, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein include the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

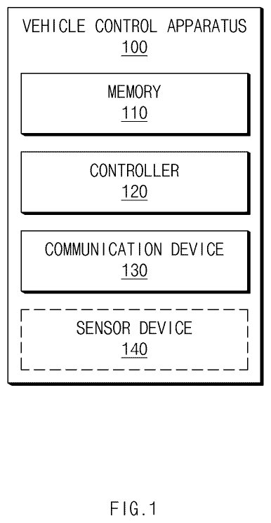

Hereinafter, various exemplary embodiments of the present disclosure will be described in detail with reference to FIGS. 1 to 6.

FIG. 1 is a block diagram illustrating components of a vehicle control apparatus according to an exemplary embodiment of the present disclosure.

According to an exemplary embodiment of the present disclosure, a vehicle control apparatus 100 may include a memory 110, a controller 120, a communication device 130, and/or a sensor device 140. The components of the vehicle control apparatus 100, which are shown in FIG. 1, are illustrative, and embodiments of the present disclosure are not limited thereto. For example, the vehicle control apparatus 100 may further include components (e.g., at least one of an interface, a display, or a notification device, or any combination thereof) which are not shown in FIG. 1.

According to an exemplary embodiment of the present disclosure, the memory 110 may store a command or data. For example, the memory 110 may store one or more instructions, when executed by the controller 120, causing the vehicle control apparatus 100 to perform various operations.

For example, the memory 110 and the controller 120 may be implemented as one chipset. The controller 120 may include at least one of a communication processor or a modem.

For example, the memory 110 may store various pieces of information associated with the vehicle control apparatus 100. As an exemplary embodiment of the present disclosure, the memory 110 may store information related to an operation history of the controller 120. As an exemplary embodiment of the present disclosure, the memory 110 may store information associated with states and/or operations of components (e.g., at least one of an engine control unit (ECU), the memory 110, the controller 120, the communication device 130, or the sensor device 140, or any combination thereof) of a host vehicle.

For example, the memory 110 may include a plurality of different types of storage devices. For example, the memory 110 may include at least one of a random-access memory (RAM) or an embedded multi-media card (eMMC), or any combination thereof.

For example, the memory 110 may store information (e.g., a diagnostic trouble code (DTC)) about a fault which occurs in a communication process between target devices (e.g., a plurality of control units) mounted in the host vehicle.

According to an exemplary embodiment of the present disclosure, the controller 120 may be operatively connected to the memory 110, the communication device 130, and/or the sensor device 140. For example, the controller 120 may be configured for controlling operations of the memory 110, the communication device 130, and/or the sensor device 140.

For example, the controller 120 may perform a first peripheral component interconnect express (PCIe) reset and a first link-up for PCIe communication between target devices, using the communication device 130.

As an exemplary embodiment of the present disclosure, the target devices may be at least some of control units included in the vehicle control apparatus 100. The target devices may be, for example, at least some of the plurality of control units included in the controller 120. The target devices may include, for example, a plurality of application processors (APs). The target devices may include, for example, at least one device corresponding to RootComplex and End-point.

As an exemplary embodiment of the present disclosure, before performing PCIe communication between the target devices, the controller 120 may perform a PCIe reset for each of the target devices.

As an exemplary embodiment of the present disclosure, after performing the first PCIe reset, the controller 120 may perform a link-up for performing PCIe communication. The link-up may include at least one of, for example, link equalization, link training, or link enumeration, or any combination thereof.

As an exemplary embodiment of the present disclosure, the controller 120 may perform PCIe communication based on a link training & status state machine (LTSSM) including information related to a state required to perform the PCIe communication between the target devices. The LTSSM may be divided according to, for example, a kind and/or type of the link-up and may be stored in the memory 110. The LTSSM may include a plurality of units (e.g., 11 units) and may include a sub-state corresponding to each unit. For example, after the first link-up is completed, the controller 120 may monitor whether the target devices perform communication in a normal state (e.g., LO state) corresponding to the first link-up.

For example, the controller 120 may be configured to determine a PCIe parameter, based on at least one of a communication speed between the target devices, abnormal information, whether a fault is identified, or real-time temperatures of the target devices, or any combination thereof.

For example, if it is identified that the communication speed between the target devices is less than a specified speed, the controller 120 may monitor whether the target devices enter a reset safety state. The specified speed may be, for example, a speed value previously stored in the memory 110. For example, if it is identified that the target devices enter the reset safety state, the controller 120 may be configured to determine a PCIe parameter based on a magnitude of the communication speed.

As an exemplary embodiment of the present disclosure, if controlling the host vehicle using only one of the target devices, the controller 120 may be configured to determine that the target devices enter the reset safety state.

As an exemplary embodiment of the present disclosure, if controlling the host vehicle using the target devices without using the PCIe communication, the controller 120 may be configured to determine that the target devices enter the reset safety state.

As an exemplary embodiment of the present disclosure, in response that the controller concludes that a time required to perform a reset for the target devices is less than or equal to a predetermined time in the situation in which the controller 120 controls the host vehicle using the target devices based on the PCIe communication, the controller 120 may be configured to determine that the target devices enter the reset safety state.

As an exemplary embodiment of the present disclosure, if identifying the power state of the vehicle control apparatus 100 switches from OFF to ON, the controller 120 may be configured to determine that a PCIe reset trigger is generated. Alternatively, if identifying the power state of the vehicle control apparatus 100 switches from OFF to ON, the controller 120 may be configured to determine that the target devices enter the reset safety state.

For example, if the first link-up is completed, the controller 120 may monitor whether abnormal information related to communication performance during performing PCIe communication between the target devices is identified and may be configured to determine a PCIe parameter based on the abnormal information, if the abnormal information is identified.

As an exemplary embodiment of the present disclosure, if it is identified that the communication speed is less than a first speed according to the first link-up (or a maximum speed supportable through the first link-up) or that the PCIe communication does not meet a link training & status state machine (LTSSM) according to the first link-up, the controller 120 may be configured to determine that the abnormal information is identified.

For example, in response that the controller concludes that the communication speed is greater than or equal to a specified speed and that the abnormal information is not identified, the controller 120 may monitor whether a fault is identified while performing PCIe communication and may be configured to determine a PCIe parameter depending on whether it is possible to recover the fault, if the fault is identified.

As an exemplary embodiment of the present disclosure, if the fault is identified, the controller 120 may be configured to determine whether the fault is included in a recoverable range and may monitor the target devices enter the reset safety state, if the fault is included in the recoverable range. If it is identified that the target devices enter the reset safety state, for example, the controller 120 may be configured to determine a PCIe parameter based on information related to the fault.

As an exemplary embodiment of the present disclosure, if the fault is not included in the recoverable range, the controller 120 may identify the fault as a permanent fault and may store the information (e.g., a diagnostic trouble code (DTC)) about the fault in the memory 110.

As an exemplary embodiment of the present disclosure, the controller 120 may be configured to determine whether the fault is included in the recoverable range based on at least one of a temperature, impedance, or dependency, or any combination thereof. The controller 120 may identify at least one of, for example, an external temperature (e.g., a temperature of an area adjacent to the target devices) or impedance of the target devices, or any combination thereof. For example, if it is identified that the fault occurs due to the external temperature or the impedance or if it is identified that the fault includes a communication delay due to dependency between the target devices, the controller 120 may be configured to determine that the fault is included in the recoverable range.

For example, the controller 120 may be configured to determine a PCIe parameter based on a real-time temperature of each of the target devices.

As an exemplary embodiment of the present disclosure, the controller 120 may obtain the real-time temperature of each of the target devices using the sensor device 140 and may be configured to determine the PCIe parameter, based on a result of comparing the real-time temperatures of the target devices.

For example, the PCIe parameter may include a parameter (e.g., configuration) defined for PCIe communication between the target devices. The controller 120 may perform a link-up between the target devices based on the PCIe parameter and may establish PCIe communication.

According to an exemplary embodiment of the present disclosure, the communication device 130 may assist in establishing a communication channel (e.g., a wireless communication channel) between the vehicle control apparatus 100 and an external device and communicating over the established communication channel.

For example, the communication device 130 may assist in establishing a communication channel between a plurality of control units (e.g., the target devices) included in the vehicle control apparatus 100 and performing communication (e.g., PCIe communication) over the established communication channel.

For example, the communication device 130 may include one or more communication processors which operate independently of the controller 120 (e.g., an application processor) and support direct (e.g., wired) communication or wireless communication.

For example, the communication device 130 may include a wireless communication module (e.g., a cellular communication module, a short range wireless communication module, or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, wireless-fidelity (Wi-Fi) Direct, or infrared data association (IrDA)) or a second network (e.g., a long range communication network such as a legacy cellular network, a fifth generation (5G) network, a next-generation communication network, the Internet, or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. Furthermore, the communication device 130 and the controller 120 may be implemented as a single chip.

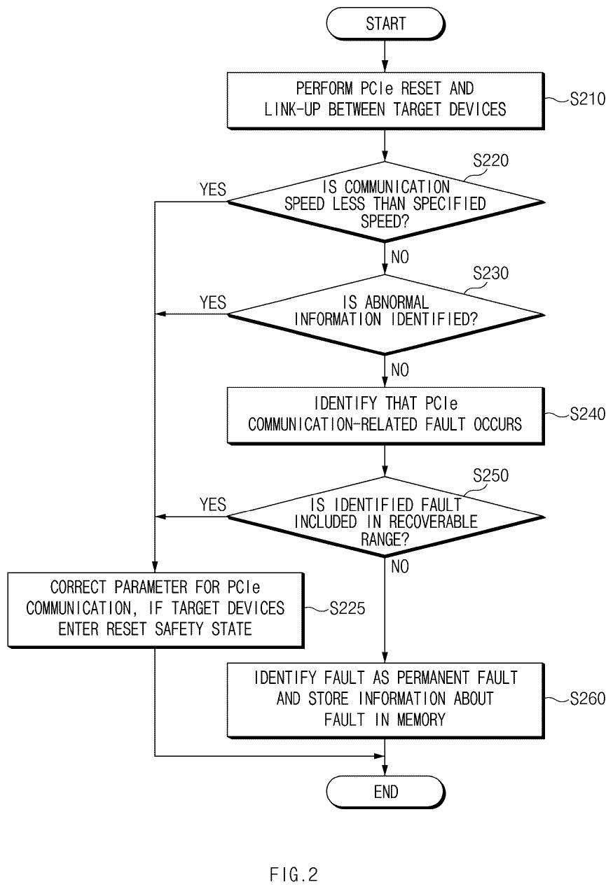

FIG. 2 is a flowchart of a vehicle control method according to an exemplary embodiment of the present disclosure.

According to an exemplary embodiment of the present disclosure, a vehicle control apparatus (e.g., a vehicle control apparatus 100 of FIG. 1) may perform operations included in FIG. 2. For example, at least some of components (e.g., a memory 110, a controller 120, a communication device 130, and/or a sensor device 140 of FIG. 1) included in the vehicle control apparatus may be configured to perform operations of FIG. 2.

Operations in S210 to S260 in an exemplary embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 2, may be briefly described or omitted.

According to an exemplary embodiment of the present disclosure, in S210, the vehicle control apparatus may perform a PCIe reset and a link-up between target devices.

According to an exemplary embodiment of the present disclosure, in S220, the vehicle control apparatus may be configured to determine whether a communication speed is less than a specified speed.

For example, if the link-up between the target devices is completed, the vehicle control apparatus may identify a real-time communication speed. For example, the specified speed may be a maximum speed defined according to a kind and/or type of the link-up. In other words, the specified speed may be a maximum speed supportable through the link-up.

For example, if the communication speed is less than the specified speed (e.g., S220—YES), the vehicle control apparatus may perform S225.

For example, if the communication speed is greater than or equal to the specified speed (e.g., S220—NO), the vehicle control apparatus may perform S230.

According to an exemplary embodiment of the present disclosure, if the target devices enter a reset safety state, in S225, the vehicle control apparatus may correct (or change) a parameter for PCIe communication.

According to an exemplary embodiment of the present disclosure, in S230, the vehicle control apparatus may be configured to determine whether abnormal information is identified.

For example, the vehicle control apparatus may be configured to determine whether communication performance does not match predetermined communication performance, in a process of establishing the PCIe communication.

For example, if the abnormal information is identified (e.g., S230—YES), the vehicle control apparatus may perform S225.

For example, if the abnormal information is not identified (e.g., S230—NO), the vehicle control apparatus may perform S240.

According to an exemplary embodiment of the present disclosure, in S240, the vehicle control apparatus may identify whether a PCIe communication-related fault occurs.

For example, the vehicle control apparatus may monitor whether the fault occurs in real time, in a process of performing PCIe communication between the target devices.

According to an exemplary embodiment of the present disclosure, in S250, the vehicle control apparatus may be configured to determine whether the identified fault is included in a recoverable range.

For example, if the fault is included in the recoverable range (e.g., S250—YES), the vehicle control apparatus may perform S225.

For example, if the fault is not included in the recoverable range (e.g., S250—NO), the vehicle control apparatus may perform S60.

According to an exemplary embodiment of the present disclosure, in S260, the vehicle control apparatus may identify the fault as a permanent fault and may store information (e.g., DTC) about the fault in its memory.

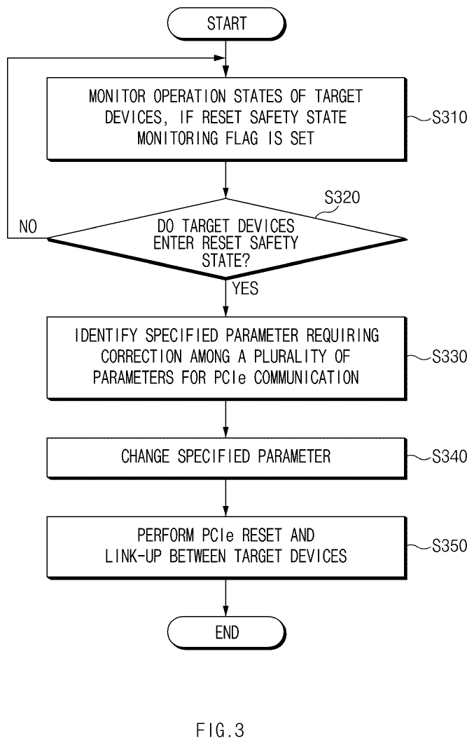

FIG. 3 is a flowchart of a vehicle control method according to an exemplary embodiment of the present disclosure.

According to an exemplary embodiment of the present disclosure, a vehicle control apparatus (e.g., a vehicle control apparatus 100 of FIG. 1) may perform operations included in FIG. 3. For example, at least some of components (e.g., a memory 110, a controller 120, a communication device 130, and/or a sensor device 140 of FIG. 1) included in the vehicle control apparatus may be configured to perform operations of FIG. 3.

Operations in S310 to S350 in an exemplary embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 3, may be briefly described or omitted.

According to an exemplary embodiment of the present disclosure, if a reset safety state monitoring flag is set, in S310, the vehicle control apparatus may monitor operation states of target devices.

For example, after performing a first link-up between the target devices, the vehicle control apparatus may set the reset safety state monitoring flag, if it is identified that a communication speed is less than a specified speed, that abnormal information is identified, or that a fault included in a recoverable range occurs in a PCIe communication process.

According to an exemplary embodiment of the present disclosure, in S320, the vehicle control apparatus may be configured to determine whether the target devices enter a reset safety state.

As an exemplary embodiment of the present disclosure, if a controller controls a host vehicle using only one of the target devices, the vehicle control apparatus may be configured to determine that the target devices enter the reset safety state.

As an exemplary embodiment of the present disclosure, if the controller controls the host vehicle using the target devices without using PCIe communication, the vehicle control apparatus may be configured to determine that the target devices enter the reset safety state.

As an exemplary embodiment of the present disclosure, if it is identified that a time required to perform a reset of the target devices is less than or equal to a predetermined time in the situation in which the controller controls the host vehicle using the target devices based on the PCIe communication, the vehicle control apparatus may be configured to determine that the target devices enter the reset safety state.

For example, if identifying the power state of the vehicle control apparatus switches from OFF to ON, the vehicle control apparatus may be configured to determine that the target devices enter the reset safety state.

For example, if the target devices enter the reset safety state (e.g., S320—YES), the vehicle control apparatus may perform S330.

For example, if the target devices do not enter the reset safety state (e.g., S320—NO), the vehicle control apparatus may repeatedly perform S310.

According to an exemplary embodiment of the present disclosure, in S330, the vehicle control apparatus may identify whether a specified parameter requiring correction among a plurality of parameters for PCIe communication.

For example, the vehicle control apparatus may identify the specified parameter among a plurality of PCIe parameters defined in response to a link-up, based on a configuration to enter the reset safety state among a communication speed, abnormal information, and a fault.

According to an exemplary embodiment of the present disclosure, in S340, the vehicle control apparatus may change the specified parameter.

For example, the vehicle control apparatus may change the specified parameter, based on at least one of a size of the configuration to enter the reset safety state among the communication speed, the abnormal information, and the fault, a degree of the configuration, or a type of the configuration, or any combination thereof.

According to an exemplary embodiment of the present disclosure, in S350, the vehicle control apparatus may perform a PCIe reset and a second link-up between the target devices.

For example, the vehicle control apparatus may perform the PCIe reset of the target devices and may perform the second link-up based on the changed parameter.

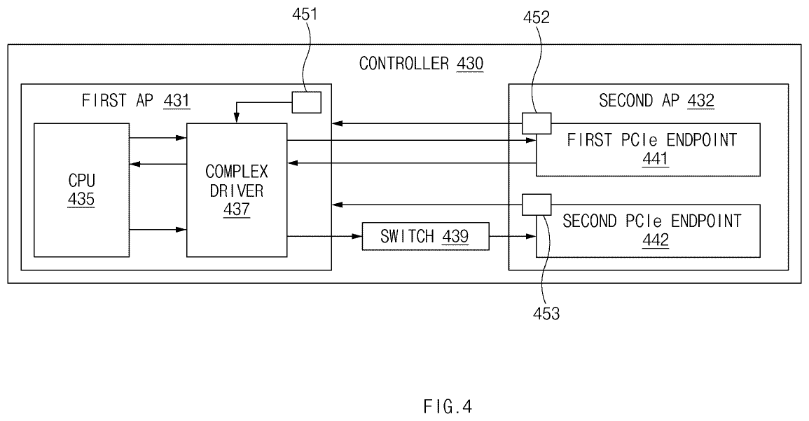

FIG. 4 is an operational conceptual diagram of a vehicle control method according to an exemplary embodiment of the present disclosure.

According to an exemplary embodiment of the present disclosure, a vehicle control apparatus (e.g., a vehicle control apparatus 100 of FIG. 1) may include a controller 430 (e.g., a controller 120 of FIG. 1).

For example, the controller 430 may include at least one control unit including a first AP 431 and a second AP 432.

As an exemplary embodiment of the present disclosure, the first AP 431 may be a main processor including a central processing unit (CPU) 435 and a complex driver 437.

As an exemplary embodiment of the present disclosure, the second AP 432 may be an auxiliary processor including at least one endpoint (e.g., a first PCIe endpoint 441 and a second PCIe endpoint 442).

As an exemplary embodiment of the present disclosure, at least a portion (e.g., the second PCIe endpoint 442) of the first AP 431 and the second AP 432 may be electrically connected through a switch 439.

As an exemplary embodiment of the present disclosure, the vehicle control apparatus may obtain information related to each of the control units, using at least one sensor (e.g., a first sensor 451, a second sensor 452, and a third sensor 453).

As an exemplary embodiment of the present disclosure, the vehicle control apparatus may obtain a temperature of at least a part (e.g., the complex driver 437) of the first AP 431 using the first sensor 451.

As an exemplary embodiment of the present disclosure, the vehicle control apparatus may obtain a temperature of at least a part (e.g., the first PCIe endpoint 441) of the second AP 432 using the second sensor 452.

As an exemplary embodiment of the present disclosure, the vehicle control apparatus may obtain a temperature of at least a part (e.g., the second PCIe endpoint 442) of the second AP 432 using the third sensor 453.

For example, the vehicle control apparatus may be configured to determine a PCIe parameter for PCIe communication between the plurality of control units (or target devices), based on the obtained temperature.

As an exemplary embodiment of the present disclosure, the vehicle control apparatus may compare magnitudes of real-time temperatures of the plurality of control units and may be configured to determine a PCIe parameter based on the compared result.

The components of the vehicle control apparatus, which are shown in FIG. 4, are illustrative, and embodiments of the present disclosure are not limited thereto. For example, the vehicle control apparatus may further include components (e.g., a communication device, an interface, a display, a notification device, or a sensor device, or any combination thereof) which are not shown in FIG. 4.

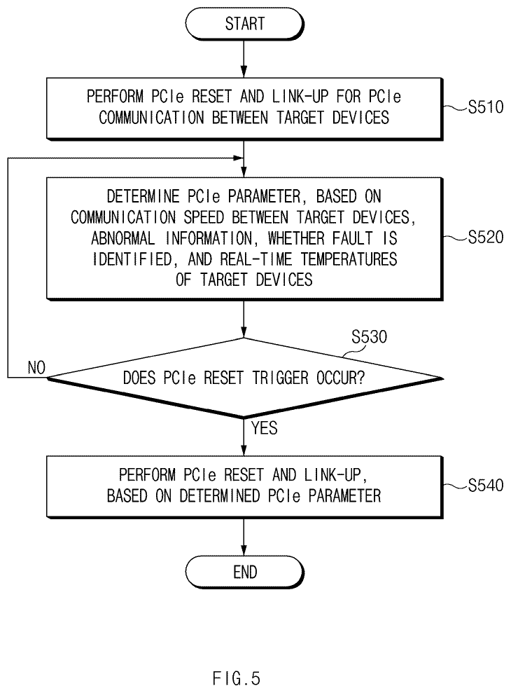

FIG. 5 is a flowchart of a vehicle control method according to an exemplary embodiment of the present disclosure.

According to an exemplary embodiment of the present disclosure, a vehicle control apparatus (e.g., a vehicle control apparatus 100 of FIG. 1) may perform operations included in FIG. 5. For example, at least some of components (e.g., a memory 110, a controller 120, a communication device 130, and/or a sensor device 140 of FIG. 1) included in the vehicle control apparatus may be configured to perform operations of FIG. 5.

Operations in S510 to S540 in an exemplary embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 5, may be briefly described or omitted.

According to an exemplary embodiment of the present disclosure, in S510, the vehicle control apparatus may perform a PCIe reset (e.g., a first PCIe reset) and a link-up (e.g., a first link-up) for PCIe communication between target devices.

According to an exemplary embodiment of the present disclosure, in S520, the vehicle control apparatus may be configured to determine a PCIe parameter, based on a communication speed between the target devices, abnormal information, whether a fault is identified, and real-time temperatures of the target devices.

According to an exemplary embodiment of the present disclosure, in S530, the vehicle control apparatus may identify whether a PCIe reset trigger is generated.

For example, if the vehicle control apparatus loses power and restarts, it may identify that the PCIe reset trigger is generated.

For example, if it is identified that the PCIe reset trigger is generated (e.g., S530—YES), the vehicle control apparatus may perform S540.

For example, if it is identified that the PCIe reset trigger is not generated (e.g., S530—NO), the vehicle control apparatus may repeatedly perform S520.

According to an exemplary embodiment of the present disclosure, in S540, the vehicle control apparatus may perform a PCIe reset (e.g., a second PCIe reset) and a link-up (e.g., a second link-up), based on the determined PCIe parameter.

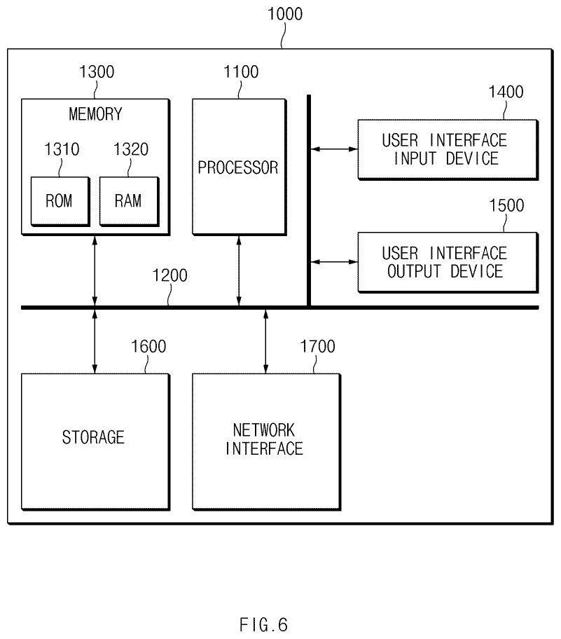

FIG. 6 illustrates a computing system associated with a vehicle control apparatus or a vehicle control method according to an exemplary embodiment of the present disclosure.

Referring to FIG. 6, a computing system 1000 about the vehicle control apparatus or the vehicle control method may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the exemplary embodiments included in the specification may be directly implemented with a hardware module, a software module, or a combination of the hardware module and the software module, which is executed by the processor 1100. The software module may reside on a storage medium (that is, the memory and/or the storage) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be provided of effects of the vehicle control apparatus and the method thereof according to an exemplary embodiment of the present disclosure.

Embodiments of the present disclosure may provide the vehicle control apparatus configured to adaptively change a PCIe parameter (e.g., a PCIe configuration) to maintain stable communication performance, if deterioration in communication performance is identified, after performing a reset for target devices for performing PCIe communication and/or while the target devices perform the PCIe communication, and the vehicle control method.

Embodiments of the present disclosure may provide the vehicle control apparatus configured to perform a link-up between the target devices again based on a PCIe parameter determined according to a magnitude of a communication speed if a PCIe reset trigger for instructing to reset the target devices again is generated, if the communication speed is less than a maximum speed according to the link-up, after performing the link-up for PCIe communication, and the vehicle control method.

Embodiments of the present disclosure may provide the vehicle control apparatus configured to perform a reset and a link-up for the target devices again based on a PCIe parameter determined according to a fault if the fault is included in the recoverable range, if identifying that the fault occurs in a process of performing PCIe communication in the target devices, and store information related to the fault in the memory, if the fault occurring is included in the recoverable range, and the vehicle control method.

Furthermore, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle control apparatus, comprising:
a communication device;
a memory storing at least one instruction; and
a controller operatively connected to the communication device and the memory,
wherein the at least one instruction executed by the controller is configured to, cause the vehicle control apparatus to:
perform a first peripheral component interconnect express (PCIe) reset and a first link-up for PCIe communication between target devices, using the communication device;
determine a PCIe parameter, based on at least one of a communication speed between the target devices, abnormal information, whether a fault is identified, or real-time temperatures of the target devices, or any combination thereof;
perform a second PCIe reset for the target devices, in response that the controller concludes that a PCIe reset trigger is generated; and
perform a second link-up between the target devices based on the determined PCIe parameter, in response that the second PCIe reset is completed.

2. The vehicle control apparatus of claim 1, wherein the at least one instruction executed by the controller is further configured to, cause the vehicle control apparatus to:
monitor whether the target devices enter a reset safety state, in response that the controller identifies that the communication speed between the target devices is less than a predetermined speed; and
determine the PCIe parameter based on the communication speed, in response that the controller identifies that the target devices enter the reset safety state.

3. The vehicle control apparatus of claim 2, wherein the at least one instruction executed by the controller is further configured to, cause the vehicle control apparatus to:
control a host vehicle using one of the target devices by the controller;
control the host vehicle using the target devices without using the PCIe communication by the controller; or
determine that the target devices enter the reset safety state, in response that the controller identifies that a time required to perform a reset for the target devices, in a situation in which the controller controls the host vehicle using the target devices based on the PCIe communication, is less than or equal to a predetermined time.

4. The vehicle control apparatus of claim 1, wherein the at least one instruction executed by the controller is further configured to, cause the vehicle control apparatus to:
determine that the PCIe reset trigger is generated, in response that the controller identifies that a power state of the vehicle control apparatus switches from OFF to ON.

5. The vehicle control apparatus of claim 1, wherein the at least one instruction executed by the controller is further configured to, cause the vehicle control apparatus to:
monitor whether the abnormal information related to communication performance while performing the PCIe communication between the target devices is identified, in response that the first link-up is completed; and
determine the PCIe parameter based on the abnormal information, in response that the abnormal information is identified.

6. The vehicle control apparatus of claim 5, wherein the at least one instruction executed by the controller is further configured to, cause the vehicle control apparatus to:
determine that the abnormal information is identified, in response that the controller concludes that the communication speed is less than a first speed according to the first link-up or that the PCIe communication does not meet a link training & status state machine (LTSSM) according to the first link-up.

7. The vehicle control apparatus of claim 1, wherein the at least one instruction executed by the controller is further configured to, cause the vehicle control apparatus to:
monitor whether the fault is identified while performing the PCIe communication, in response that the controller concludes that the communication speed is greater than or equal to a predetermined speed and that the abnormal information is not identified;
determine whether the fault is included in a recoverable range, in response that the fault is identified;
monitor whether the target devices enter a reset safety state, in response that the fault is included in the recoverable range; and
determine the PCIe parameter based on information related to the fault, in response that the controller identifies that the target devices enter the reset safety state.

8. The vehicle control apparatus of claim 1, wherein the at least one instruction executed by the controller is further configured to, cause the vehicle control apparatus to:
monitor whether the fault is identified while performing the PCIe communication, in response that the controller concludes that the communication speed is greater than or equal to a predetermined speed and that the abnormal information is not identified;
determine whether the fault is included in a recoverable range, in response that the fault is identified; and
identify the fault as a permanent fault and store information related to the fault in the memory, in response that the fault is not included in the recoverable range.

9. The vehicle control apparatus of claim 7, further including:
a sensor device operatively connected to the controller,
wherein the at least one instruction executed by the controller is further configured to, cause the vehicle control apparatus to:
identify at least one of an external temperature or impedance of the target devices, or any combination thereof, using the sensor device; and
determine that the fault is included in the recoverable range, in response that the controller identifies that the fault occurs due to the external temperature or the impedance or in response that the controller identifies that the fault includes a communication delay due to dependency between the target devices.

10. The vehicle control apparatus of claim 1, further including:
a sensor device operatively connected to the controller,
wherein the at least one instruction executed by the controller is further configured to, cause the vehicle control apparatus to:
obtain the real-time temperature of each of the target devices, using the sensor device; and
determine the PCIe parameter, based on a result of comparing the real-time temperatures of the target devices.

11. A vehicle control method, comprising:
performing, by a controller, a first peripheral component interconnect express (PCIe) reset and a first link-up for PCIe communication between target devices, using a communication device operatively connected to the controller;
determining, by the controller, a PCIe parameter, based on at least one of a communication speed between the target devices, abnormal information, whether a fault is identified, or real-time temperatures of the target devices, or any combination thereof;
performing, by the controller, a second PCIe reset for the target devices, in response that the controller concludes that a PCIe reset trigger is generated; and
performing, by the controller, a second link-up between the target devices based on the determined PCIe parameter, in response that the second PCIe reset is completed.

12. The vehicle control method of claim 11, further including:
monitoring, by the controller, whether the target devices enter a reset safety state, in response that the controller identifies that the communication speed between the target devices is less than a predetermined speed; and
determining, by the controller, the PCIe parameter based on the communication speed, in response that the controller identifies that the target devices enter the reset safety state.

13. The vehicle control method of claim 12, further including:
controlling, by the controller, a host vehicle using one of the target devices;
controlling, by the controller, the host vehicle using the target devices without using the PCIe communication; or
determining, by the controller, that the target devices enter the reset safety state, in response that the controller identifies that a time required to perform a reset for the target devices, in a situation in which the controller controls the host vehicle using the target devices based on the PCIe communication, is less than or equal to a predetermined time.

14. The vehicle control method of claim 11, further including:
determining, by the controller, that the PCIe reset trigger is generated, in response that the controller identifies that a power state of the vehicle control apparatus switches from OFF to ON.

15. The vehicle control method of claim 11, further including:
monitoring whether the abnormal information related to communication performance while performing the PCIe communication between the target devices is identified, in response that the first link-up is completed; and
determining, by the controller, the PCIe parameter based on the abnormal information, in response that the abnormal information is identified.

16. The vehicle control method of claim 15, further including:
determining, by the controller, that the abnormal information is identified, in response that the controller concludes that the communication speed is less than a first speed according to the first link-up or that the PCIe communication does not meet a link training & status state machine (LTSSM) according to the first link-up.

17. The vehicle control method of claim 11, further including:
monitoring, by the controller, whether the fault is identified while performing the PCIe communication, in response that the controller concludes that the communication speed is greater than or equal to a predetermined speed and that the abnormal information is not identified;
determining, by the controller, whether the fault is included in a recoverable range, in response that the fault is identified;
monitoring whether the target devices enter a reset safety state, in response that the fault is included in the recoverable range; and
determining, by the controller, the PCIe parameter based on information related to the fault, in response that the controller identifies that the target devices enter the reset safety state.

18. The vehicle control method of claim 11, further including:
monitoring, by the controller, whether the fault is identified while performing the PCIe communication, in response that the controller concludes that the communication speed is greater than or equal to a predetermined speed and that the abnormal information is not identified;
determining, by the controller, whether the fault is included in a recoverable range, in response that the fault is identified; and
identifying, by the controller, the fault as a permanent fault and storing, by the controller, information related to the fault in a memory, in response that the fault is not included in the recoverable range.

19. The vehicle control method of claim 17, further including:
identifying at least one of an external temperature or impedance of the target devices, or any combination thereof, using a sensor device operatively connected to the controller; and
determining, by the controller, that the fault is included in the recoverable range, in response that the controller identifies that the fault occurs due to the external temperature or the impedance or in response that the controller identifies that the fault includes a communication delay due to dependency between the target devices.

20. The vehicle control method of claim 11, further including:
obtaining, by the controller, the real-time temperature of each of the target devices, using a sensor device operatively connected to the controller; and
determining the PCIe parameter, based on a result of comparing the real-time temperatures of the target devices.
